(19) United States
(12) Patent Application Publication
(10) Pub. No.: US 2018/0211184 A1
(43) Pub. Date: Jul. 26, 2018

(54) METHOD AND SYSTEM FOR VIRTUAL CONNECTION BETWEEN TRAVELER AND LOCAL CONCIERGE BASED ON SIMILAR INTERESTS BACKGROUND

(71) Applicant: Mehdi El Mountassir, Los Angeles, CA (US)

(72) Inventor: Mehdi El Mountassir, Los Angeles, CA (US)

(21) Appl. No.: 15/876,118

(22) Filed: Jan. 20, 2018

Related U.S. Application Data
(60) Provisional application No. 62/448,949, filed on Jan. 20, 2017.

(51) Int. Cl. G06Q 10/02

(52) U.S. Cl. CPC G06Q 10/02

(57) ABSTRACT

In an approach for connecting a traveler with a remote concierge. A processor gathers a first set of data associated with at least one concierge. A processor collects a second set of data associated with a traveler. A processor compares the first set of data and the second set of data, wherein the data is compared to determine if a match is made between the at least one concierges and the traveler. A processor presents a portion of the at least one concierges to the traveler. A processor receives a selection of one of the concierges by the traveler. A processor connects the selected concierge and the traveler, wherein the concierge and the traveler establish an itinerary.

### BACKGROUND

This disclosure relates generally for connecting people looking for assistance, and more specifically to a method, computer program and computer system for providing real-time concierge services.

Talking with locals is the best way to learn about a new city or place, but it can be intimidating and awkward to meet new locals while traveling. Often, language barriers serve as one reason to make it impracticable to communicate effectively with locals while traveling. Additionally, it is difficult to receive good recommendations from someone if you do not know them or have a way of communicating with them.

Some travelers conduct research on the Internet and use travel-planning tool to help collect ideas for their trip. However, existing planning tools can be unreliable as many sources are left unverified and outdated. Other travelers hire professional travel agents to get a personalized day-by-day itinerary for their vacation, but these travel agents may lack the insider knowledge to truly plan or recommend points of interest like a local. Thus, there is a need for a platform that can connect travelers with everyday locals for providing travel itinerary and trip recommendations. In this regard, the invention described herein addresses this problem.

Therefore, it is desired for a method, computer program, or computer system to connect these individuals with people that are able to help and assist them with their travel plans and itinerary.

### SUMMARY

A first aspect of the present invention provides a method for connecting a traveler with a remote concierge. Wherein the method is gathering a first set of data associated with at least one concierge. Collecting a second set of data associated with a traveler. Comparing the first set of data and the second set of data, wherein the data is compared to determine if a match is made between the at least one concierges and the traveler. Presenting a portion of the at least one concierges to the traveler. Receiving a selection of one of the concierges by the traveler. Connecting the selected concierge and the traveler, wherein the concierge and the traveler establish an itinerary.

A second aspect of the present invention provides a computer program product for connecting a traveler with a remote concierge. Wherein the method is gathering a first set of data associated with at least one concierge. Collecting a second set of data associated with a traveler. Comparing the first set of data and the second set of data, wherein the data is compared to determine if a match is made between the at least one concierges and the traveler. Presenting a portion of the at least one concierges to the traveler. Receiving a selection of one of the concierges by the traveler. Connecting the selected concierge and the traveler, wherein the concierge and the traveler establish an itinerary.

A third aspect of the present invention provides a computer system for connecting a traveler with a remote concierge. Wherein the method is gathering a first set of data associated with at least one concierge. Collecting a second set of data associated with a traveler. Comparing the first set of data and the second set of data, wherein the data is compared to determine if a match is made between the at least one concierges and the traveler. Presenting a portion of the at least one concierges to the traveler. Receiving a selection of one of the concierges by the traveler. Connecting the selected concierge and the traveler, wherein the concierge and the traveler establish an itinerary.

### BRIEF DESCRIPTION OF THE DRAWINGS

FIG. 1 depicts a block diagram depicting a computing environment, in accordance with one embodiment of the present invention.

FIG. 2 depicts a flowchart of the operational steps taken by connection program to locate people with similar interests as a traveler and connect the individuals using a computing device within the computing environment of FIG. 1, in accordance with an embodiment of the present invention.

FIG. 3 depicts a block diagram depicting the internal and external components of the computing devices and servers of FIG. 1, in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

Embodiments of the present invention discloses a system, method, or computer program that allows people to locate other individuals based on a set of predetermined characteristics and interests. This provides advantageous when traveling to a new city and do not have any or much knowledge of the area and would desire a local or person of greater knowledge to assist you in discovering the city or area.

The present invention will now be described in detail with reference to the Figures.

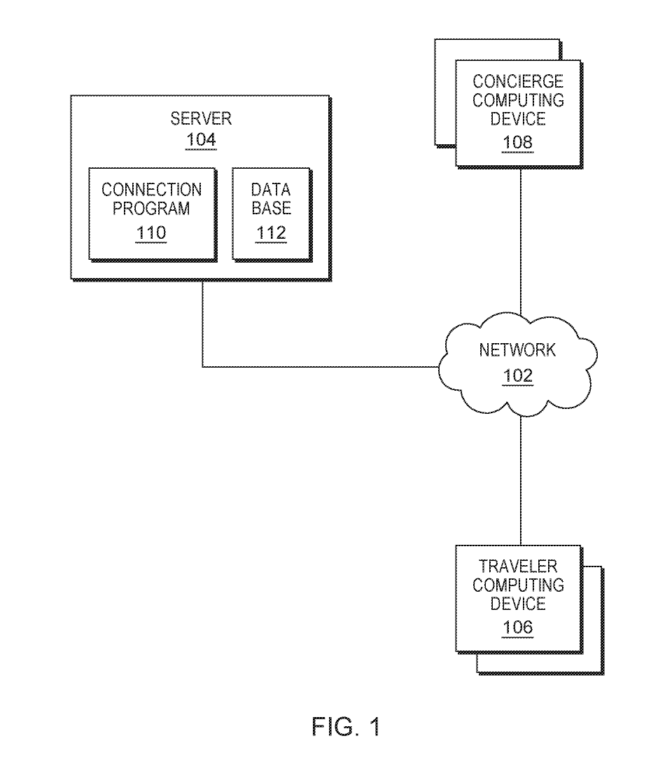

FIG. 1 depicts a block diagram of a computing environment 100 in accordance with one embodiment of the present invention. FIG. 1 provides an illustration of one embodiment and does not imply any limitations regarding the environment in which different embodiments maybe implemented.

In the depicted embodiment, computing environment 100 includes network 102, server 104, traveler computing device 106, and concierge computing devices 108. Computing environment 100 may include additional servers, computers, or other devices not shown.

Network 102 may be a local area network (LAN), a wide area network (WAN) such as the Internet, any combination thereof, or any combination of connections and protocols that can support communications between server 104, traveler computing device 106, and concierge computing devices 108 in accordance with embodiments of the invention. Network 102 may include wired, wireless, or fiber optic connections.

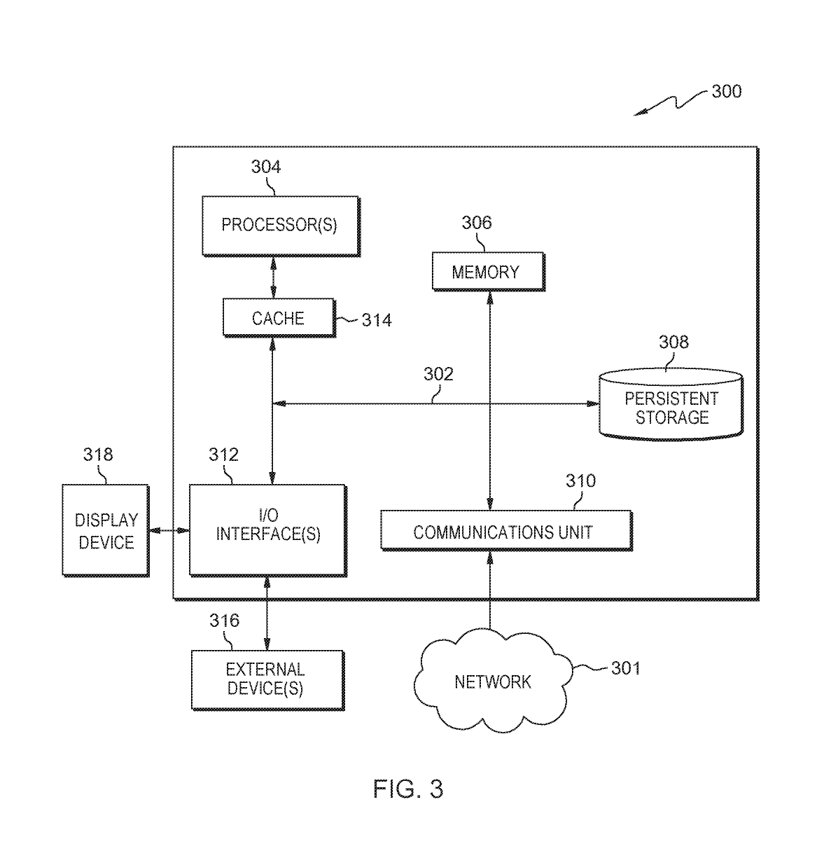

Server 104 may be a management server, a web server, or any other electronic device or computing system capable of processing program instructions and receiving and sending data. In other embodiments server 104 may be a laptop computer, tablet computer, netbook computer, personal computer (PC), a desktop computer, or any programmable electronic device capable of communicating with traveler computing device 106 and concierge computing devices 108 via network 102. In one embodiment, server 104 may be a server computing system utilizing multiple computers as a server system, such as in a cloud computing environment. In one embodiment, server 104 represents a computing system utilizing clustered computers and components to act as a single pool of seamless resources. In the depicted embodiment database 112 and connection program 110 is located on server 104. Server 104 may include components, as depicted and described in further detail with respect to FIG. 3.

Traveler computing device 106 may be a management server, a web server, or any other electronic device or computing system capable of processing program instructions and receiving and sending data. In some embodiments, traveler computing device 106 may be a laptop computer, tablet computer, netbook computer, personal computer (PC), a desktop computer, or any programmable electronic device capable of communicating with server 104, and concierge computing devices 108 via network 102. Traveler computing device 106 may be one or more computing devices, wherein each computing device is associated with a different person or people. In other embodiments, traveler computing device 106 may represent a server computing system utilizing multiple computers as a server system, such as in a cloud computing environment. In another embodiment, traveler computing device 106 represents a computing system utilizing clustered computers and components to act as a single pool of seamless resources. In the depicted embodiment, traveler computing device 106 includes connection program 110. In other embodiments, traveler computing device 106 may include any combination of connection program 110 or database 112. Traveler computing device 106 may include components, as depicted and described in further detail with respect to FIG. 3.

Concierge computing devices 108 may be a management server, a web server, or any other electronic device or computing system capable of processing program instructions and receiving and sending data. Concierge computing devices 108 may be one or more computing devices, wherein each computing device is associated with a different person or people. In some embodiments, concierge computing devices 108 may be a laptop computer, tablet computer, netbook computer, personal computer (PC), a desktop computer, or any programmable electronic device capable of communicating with server 104, and traveler computing devices 106 via network 102. The concierge may be, any individual who has knowledge about a city or location and wishes to provide their knowledge to assist the travelers in planning their trip. The concierge may help in planning activities throughout the day, giving recommendations on restaurants, hotels, night life, museums, and the like that a traveler would be interested in knowing. The concierge provides local expertise and knowledge in real-time that is difficult to receive from searching the web or reading outdated books or articles. In other embodiments, concierge computing devices 108 may represent a server computing system utilizing multiple computers as a server system, such as in a cloud computing environment. In another embodiment, concierge computing devices 108 represents a computing system utilizing clustered computers and components to act as a single pool of seamless resources. In the depicted embodiment, concierge computing devices 108 includes connection program 110. In other embodiments, concierge computing devices 108 may include any combination of connection program 110 or database 112. Concierge computing devices 108 may include components, as depicted and described in further detail with respect to FIG. 3.

Connection program 110 operates to perform gather information about the concierge, information about the traveler, the requests of the traveler, and connecting the traveler with at least one concierge to initiate communication and planning. The connection program 110 analyzes various data associated with all the parties involved and allows for communication between the connected parties and the ability to plan and organize real world interactions and meetings. In the depicted embodiment, Connection program 110 is located on server 104 and utilizes network 102 to access the traveler computing device 106 and concierge computing devices 108, and communicates with database 112. In one embodiment, Connection program 110 resides on traveler computing device 106. In other embodiments, Connection program 110 may be located on numerous server or computing device, provided Connection program 110 has access to database 112.

Database 112 may be a repository that may be written to and/or read by Connection program 110. Information gathered from connection program 110 and additional computer programs and third-party programs and software may be stored to database 112. Such information may include traveler information, concierge information, program specific information and other relevant information. In one embodiment, database 112 is a database management system (DBMS) used to allow the definition, creation, querying, update, and administration of a database(s). In the depicted embodiment, database 112 resides on computing device 104. In other embodiments, database 112 resides on another server, or another computing device, provided that database 112 is accessible to connection program 110.

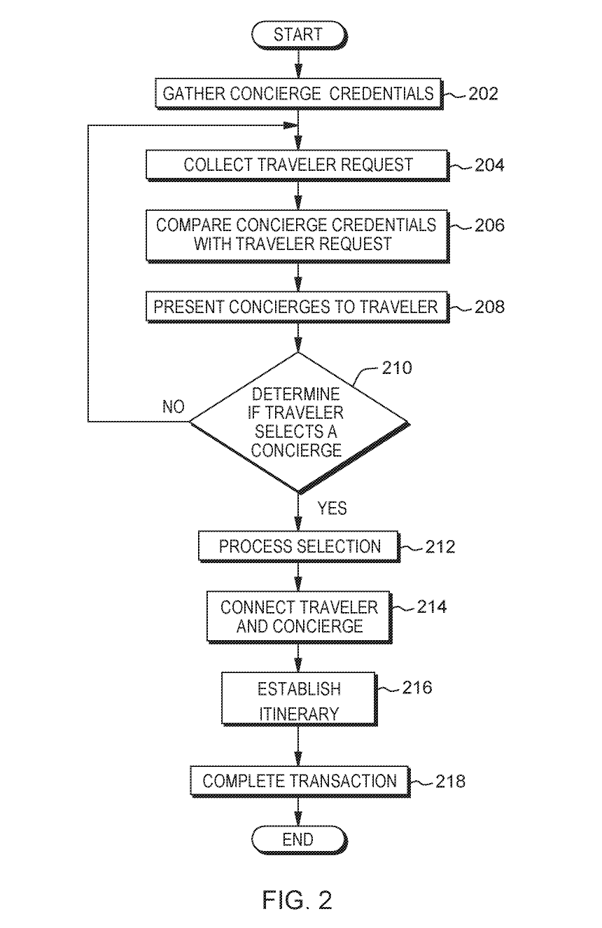

FIG. 2 shows flowchart 200 depicting a method according to the present invention. The method(s) and associated process(es) are now discussed, over the course of the following paragraphs, with extensive reference to FIG. 2, in accordance with one embodiment of the present invention.

The program(s) described herein are identified based upon the system or method for which they are implemented in a specific embodiment of the invention. However, it should be appreciated that any particular program nomenclature herein is used merely for convenience, and thus the invention should not be limited to use solely in any specific system or method identified and/or implied by such nomenclature. The system or method to generate a match between a traveler and a concierge for creating itineraries and providing advice is described. As used herein, the terms “concierge” refer to any individual who is able to provide assistance to the traveler related to their trip, planning activities, or enriching their traveling experience.

The software or method is designed to match a traveler with at least one concierge to assist the traveler with planning a trip to the destination and provide advice to the traveler. More specifically, the application is configured to create and manage traveler accounts and concierge accounts. Travelers can specify their criteria for their travel plans or itineraries. In some embodiments, travelers' criteria comprise interests or passions, preferred language, and city in which he or she wants to travel. Similarly, concierges specify their criteria for creating travel plans or itineraries. In some embodiments, concierges' criteria comprise expertise, preferred language, and city in which he or she resides. Additionally, concierges can specify fees or price points for creating travel plans or itineraries.

Upon receiving a traveler's criteria, the program searches for a concierge having matching criteria. For example, if the traveler's criteria comprise food and drink for interests, English for preferred language, and Milan for the city of travel, then a concierge who is well-versed in Milan's restaurant scene and who speaks English is matched with the traveler. If there are multiple matches, the traveler can select any one from the list. The list of concierges comprises a predetermined rating system and a fee for each concierge, to help the traveler decide their selection. If there is no match, the traveler is prompted to adjust the interest criteria. Once a match has been identified, the selected concierge can create, for example, morning, afternoon, and evening activities for the traveler and the traveler's party for each day of the trip, and assist in general questions and inquiries, make recommendations, and provide local insight into the destination for the traveler. This may be accomplished through an integrated or third-party communication platform.

In step 202, connection program 110 processes concierge credentials. Each of the concierges, provides a predetermined set of credentials to verify the person as a concierge. The credentials are a predetermined set of data to verify, authenticate, and confirm that the concierge are whom they attest to being. In one embodiments, a social security or government issued identification is the required credentials. In additional embodiments, other forms of identification are used to verify the concierge. In some embodiments, tax information is used to verify the concierge. The background check maybe done through the connection program 110 internal functions or through a third-party service connected to network 102.

In additional to the credentials are the concierge's location, time living in their current city or residence, knowledge of the area, interests, languages and proficiency of those languages, and the like. In additional embodiments, the connection program 110 gathers prices and fees associated with each concierge. In various embodiments, the concierge is able to update, change, adjust, or modify this information. In some embodiments, the concierge's criteria for becoming matched with travelers and creating travel plans. In this regard, the concierge can select areas of his or her expertise, wherein the areas of expertise mirror the interests that can be selected by traveler. Additionally, the concierge can select his or her preferred language and city of residence.

In step 204, connection program 110 collects traveler request. When a traveler accesses the connection program 110, the program requests information from the traveler associated with their travels. This information may be, but not limited to account information, traveler's criteria for his or her travel plans, e.g. destination, dates, interests, desires, and the like. In some embodiments, the traveler's criteria comprise the traveler's interests or passion, preferred language, and the city of travel. In some embodiments, the traveler can select his or her interests by making selections from a list of interests in a graphical traveler interface. Without limitation, the interests comprise shopping, theater and music, nightlife, food and drink, nature and parks, museums, landmarks, amusement parks, hotels, zoos, free (events), and spa and wellness. Additionally, the travelers can specify the number of people in his or her party and the dates of travel. In some embodiments, the connection program 110 collects positioning through various global positioning systems (GPS).

In step 206 connection program 106 compares the concierge's credentials and the traveler's request. The connection program 106 compares these to locate at least one concierge that would be able to assist the traveler in planning their trip. The connection program 106 used a predetermined portion of the concierge credentials and the traveler request to local the similarities. The comparison may, for example, have specific and predetermined factors which are weighed higher than other factors. For example, the location, availability, and interests of the concierge may weight higher than age, price, or gender. For additional examples, the connection program 110 may present all concierges in New York city who are available during the dates the traveler will be in the city, who speaks Spanish, and are knowledgeable about museums and restaurants. These variables may be adjusted and modified based on the traveler's inputs.

In step 208, connection program presented concierge(s) to the traveler. The traveler is presented with as many concierges which are analyzed and selected by the connection program 110 based on traveler requirements and recommendations and additional trade-offs for the traveler. The presented concierges are based on the traveler based on these or other attributes to assist the traveler in selecting a concierge. The number of concierges can range from zero (0) to all conceriges in the system based on the request information. In some embodiments, the concierges are ranked based on, for example, previous traveler reviews, their knowledge about the location, their location, or other factors. In additional embodiments, previously employed concierges by the traveler may be recommended to the traveler again if the relationship was successful (e.g. good rating by the traveler). In some embodiments, the connection program 110 performs an analysis based on the concierge information and the traveler's inputs to determine a similarity factor. This similarity factor establishes the likelihood of a successful match between the concierge and the traveler. In some embodiments, the information is presented to the traveler in a graphical, visual, and textual format. This may include, the concierge picture, information, rates, and additional information which could be beneficial to the traveler to select the most appropriate concierge.

In decision 210, connection program 110 determines if the traveler has selected a concierge. Once the traveler is presented with the list of available or recommended concierges, the traveler selected the concierge of their liking. If the connection program 110 determines that a concierge was selected (YES branch, proceed to step 210) the connection program 110 processes the connection. If the connection program 110 determines no concierge has been selected (NO branch, proceed to step 220) the connection program 110 recollects the traveler's requirements. In some embodiments, where no concierge is presented to the traveler because no concierges meet their requirements, the connection program 100 requests a modification of the request.

In step 212, connection program 110 process the selection. The processing of the connection connects the traveler and the concierge and fulfills the monetary association with this connection. Once the traveler completes the payment, the connection is made allowing the concierge and traveler to discuss the details of the trip.

In step 214, the connection program 110 connects the traveler with the concierge. Upon completion of the processing the selected concierge is able to communicate with the traveler to begin establishing the details about the travels. The communication may be through an integrated feature of the connection program 110 or a third-party software.

In step 216, the connection program 110 establishes the itinerary. Once the concierge and the traveler are connected, the concierge is able to communicate with the traveler, create and modify the itinerary, and provide assistance to the traveler. The concierge is provided with the traveler profile and requests for the trip to establish a structure or limitation for the events, dates, times, locations, or the like which the concierge can scheduled. The concierge is provided with a predetermined number of activities or slots for a predetermined number of days. The concierge is able to select various activities, locations, establishments for the at least one slot. This information is provided to the traveler in real-time to allow for constant communicate and input. In some embodiments, the concierge is able to input locations, events, and the like directly. In additional embodiments, the concierge is presented with preselected options based on the traveler criteria. In some embodiments, the connection program 110 communicates with third party software and programs to gather additional information about establishments, locations, events, and other relevant information about the concierge's selections or suggestions. In some embodiments, the connection program 110 purchases the tickets, passes, reservations, or the like based on the traveler's preference and the availability of the events scheduled.

In step 218, the connection program 110 concludes the transaction. After the traveler has left the destination or the predetermined time frame has expired. The traveler and the concierge are disconnected from one another. In some embodiments, at the time of conclusion, the traveler is given the opportunity to rate the concierge on a set of characteristics. In some embodiments, the concierge is given the opportunity to rate the traveler on a predetermined set of factors.

Upon the input of one activity, or the completion of the itinerary selection by the concierge, the itinerary is submitted to the traveler to review, comment, make suggestions, and request alterations. In some embodiments, as the concierge establishes the itinerary, the traveler is presented with the schedule of events and has the ability to adjust or request a modification of one or more aspects of the itinerary. This provides an alert to the concierge, based on the traveler's request, and the concierge is able to provide alternative suggestions or rescheduling of events.

The traveler may request a modification of the itinerary. Based on the traveler's criteria and the lack of concierges available or present. The connection program 110 requires the traveler to adjust their settings. In some embodiments, the connection program 110 automatically adjusts the settings based on the available concierges within the geographical area and time frame. In other embodiments, the connection program 110 provides at least one concierge based on a lower value of the similarity threshold value.

The connection between the concierge and the traveler exist until the end of the predetermined time frame selected during the processing of the connection step. This allows for up-to-date and live communication, alterations, and adjustments for the traveler, as trip plans tend to and often times do change.

FIG. 3 depicts a block diagram 300 of components of a computing device (e.g. traveler computing device 106, concierge computing devices 108, or server 104), in accordance with an illustrative embodiment of the present invention. It should be appreciated that FIG. 1 provides only an illustration of one implementation and does not imply any limitations with regard to the environments in which different embodiments may be implemented. Many modifications to the depicted environment may be made. It should be appreciated FIG. 1 provides only an illustration of one implementation and does not imply any limitations with regard to the environments in which different embodiments may be implemented.

Computing environment 300 is, in many respects, representative of the various computer subsystem(s) in the present invention. Accordingly, several portions of computing environment 300 will now be discussed in the following paragraphs.

Computing device 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any additional hardware components within a system. For example, communications fabric 302 can be implemented with one or more buses.

Computing device 300 is capable of communicating with other computer subsystems via network 301. Network 301 can be, for example, a local area network (LAN), a wide area network (WAN) such as the Internet, or a combination of the two, and can include wired, wireless, or fiber optic connections. In general, network 301 can be any combination of connections and protocols that will support communications between computing device 300 and other computing devices.

Memory 306 and persistent storage 308 are computer-readable storage media. In one embodiment, memory 306 includes random access memory (RAM) and cache memory 314. In general, memory 306 can include any suitable volatile or non-volatile computer-readable storage media.

Memory 306 is stored for execution by one or more of the respective computer processors 304 of computing device 300 via one or more memories of memory 306 of computing device 300. In the depicted embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in the examples, provides for communications with other data processing systems or devices, including computing device 300. In the examples, communications unit 310 includes one or more network interface cards. Communications unit 310 may provide communications through the use of either or both physical and wireless communications links.

I/O interface(s) 312 allows for input and output of data with other devices that may be connected to computing device 300. For example, I/O interface 312 may provide a connection to external devices 316 such as a keyboard, keypad, camera, a touch screen, and/or some other suitable input device. External devices 316 can also include portable computer-readable storage media such as, for example, thumb drives, portable optical or magnetic disks, and memory cards. Software and data used to practice embodiments of the present invention, e.g., regulation program 420 can be stored on such portable computer-readable storage media and can be loaded onto persistent storage 308 of computing device 300 via I/O interface(s) 312 of computing device 300. Software and data used to practice embodiments of the present invention, e.g., regulation program 420 can be stored on such portable computer-readable storage media and can be loaded onto persistent storage 308 of computing device 300 via I/O interface(s) 312 of computing device 300. I/O interface(s) 312 also connect to a display 318.

Display 318 provides a mechanism to display the user interface which connects the traveler and the concierge and additional data presented by connection program 110. Display may be various forms of display apparatuses, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a wave guide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the traveler's computer, partly on the traveler's computer, as a stand-alone software package, partly on the traveler and concierge computer and partly on a remote computer or entirely on the remote computer or server. In the latter scenario, the remote computer may be connected to the traveler and concierge computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

What is claimed is:

1. A method for connecting a traveler with a remote concierge, the method comprising:
gathering, by one or more computing devices, a first set of data associated with at least one concierge;
collecting, by one or more computing devices, a second set of data associated with a traveler;
comparing, by one or more processors the first set of data and the second set of data, wherein the data is compared to determine if a match is made between the at least one concierges and the traveler;
presenting, by one or more processors, a portion of the at least one concierges to the traveler;
receiving, by one or more computer devices, a selection of one of the concierges by the traveler; and
connecting, by one or more computing devices, the selected concierge and the traveler, wherein the concierge and the traveler establish an itinerary.

2. The method of claim 1, wherein the connecting of the selected concierge and the traveler, further comprising, generating, by one or more computing devices, the itinerary in real-time.

3. The method of claim 2, wherein the itinerary has a daily structure wherein each day has a plurality of segments associated with times of the day, and the selected concierge inputs events to fill the segments.

4. The method of claim 1, wherein the comparing of the first set of data and the second set of data, further comprising, establishing, by one or more processors, a hierarchy of the elements of the first set of data and the elements of the second set of data.

5. The method of claim 4, wherein the established hierarchy, further comprising, sorting, by one or more computing device, the elements of the first set of data and the second set of data based on the established hierarchy.

6. The method of claim 1, further comprising, rating, by one or more processors, the at least one concierge when presenting the portion of the at least one concierges to the traveler.

7. The method of claim 1, wherein the presentation of the portion of the at least one concierges, further comprises, arranging, by one or more computing device, the presented concierges based on at least one predetermined factor, wherein the factors may include the concierges price, rating, location, language, or availability.

8. A computer program product for connecting a traveler with a remote concierge, the method comprising:
one or more computer readable storage media and program instructions stored on the one or more computer readable storage media, the program instructions comprising:
program instructions to gather a first set of data associated with at least one concierge;
program instructions to collect a second set of data associated with a traveler;
program instructions to compare the first set of data and the second set of data, wherein the data is compared to determine if a match is made between the at least one concierges and the traveler;
program instructions to present a portion of the at least one concierges to the traveler;
program instructions to receive a selection of one of the concierges by the traveler; and
program instructions to connect the selected concierge and the traveler, wherein the concierge and the traveler establish an itinerary.

9. The computer program product of claim 8, wherein the connecting of the selected concierge and the traveler, further comprising, generating, by one or more computing devices, the itinerary in real-time.

10. The computer program product of claim 9, wherein the itinerary has a daily structure wherein each day has a plurality of segments associated with times of the day, and the selected concierge inputs events to fill the segments.

11. The computer program product of claim 8, wherein the comparing of the first set of data and the second set of data, further comprising, computer instructions to establish, a hierarchy of the elements of the first set of data and the elements of the second set of data.

12. The computer program product of claim 11, wherein the established hierarchy, further comprising, computer instructions to sort the elements of the first set of data and the second set of data based on the established hierarchy.

13. The computer program product of claim 8, further comprising, computer instructions to rate the at least one concierge when presenting the portion of the at least one concierges to the traveler.

14. The computer program product of claim 8, wherein the presentation of the portion of the at least one concierges, further comprises, computer instructions to arrange the presented concierges based on at least one predetermined factor, wherein the factors may include the concierges price, rating, location, language, or availability.

15. A computer system for connecting a traveler with a remote concierge, the method comprising:
one or more computer processors, one or more computer readable storage media, and program instructions stored on the one or more computer readable storage media for execution by, at least one of the one or more processors, the program instructions comprising:
program instructions to gather a first set of data associated with at least one concierge;
program instructions to collect a second set of data associated with a traveler;
program instructions to compare the first set of data and the second set of data, wherein the data is compared to determine if a match is made between the at least one concierges and the traveler;
program instructions to present a portion of the at least one concierges to the traveler;
program instructions to receive a selection of one of the concierges by the traveler; and
program instructions to connect the selected concierge and the traveler, wherein the concierge and the traveler establish an itinerary.

16. The computer system of claim 15, wherein the connecting of the selected concierge and the traveler, further comprising, generating, by one or more computing devices, the itinerary in real-time.

17. The computer system of claim 16, wherein the itinerary has a daily structure wherein each day has a plurality of segments associated with times of the day, and the selected concierge inputs events to fill the segments.

18. The computer system of claim 15, wherein the comparing of the first set of data and the second set of data, further comprising, computer instructions to establish, a hierarchy of the elements of the first set of data and the elements of the second set of data.

19. The computer system of claim 15, further comprising, computer instructions to rate the at least one concierge when presenting the portion of the at least one concierges to the traveler.

20. The computer system of claim 15, wherein the presentation of the portion of the at least one concierges, further comprises, computer instructions to arrange the presented concierges based on at least one predetermined factor, wherein the factors may include the concierges price, rating, location, language, or availability.
